(19) United States
(12) Patent Application Publication
(10) Pub. No.: US 2008/0277339 A1
(43) Pub. Date: Nov. 13, 2008

(54) Oil tank cleaning

(75) Inventor: Eugene Rosenberg, Givat Shmuel (IL)

Correspondence Address: Brux Software Solutions Ltd., 8 Gordon Street, Givatayim, 53235, IL

(73) Assignee: BioPetroClean Inc., Petach Tikva (IL)

(21) Appl. No.: 12/081,959

(22) Filed: Apr. 24, 2008

(30) Foreign Application Priority Data
May 9, 2007 (IL) 183075

(51) Int. Cl. C02F 3/28; C02F 1/40

(52) U.S. Cl. 210/610; 210/206

(57) ABSTRACT

A system and method for cleaning oil tanks comprising: a bio-reactor for producing bacterial cultures containing bio-emulsifiers from bacteria, air, water and sources of utilizable carbon, nitrogen and phosphate; a first pump for pumping the bacterial cultures from the bio-reactor through a first pipe into the oil tank; at least one spraying nozzle connected to the first pipe for spraying the bacterial cultures onto the oil tank's floor and walls under anaerobic conditions; and a second pump for pumping fluid out of the oil tank through a second pipe into a receiving container.

### CROSS-REFERENCE TO RELATED PATENT APPLICATIONS

This patent application claims priority from and is related to Israeli Patent Application Serial Number 183075, filed 9 May 2007, this Israeli Patent Application incorporated by reference in its entirety herein.

### FIELD OF THE INVENTION

The present invention relates to the cleaning of oil tanks, and more particularly, to economical and safe methods of cleaning cargo tank compartments of maritime vessels that carry petroleum hydrocarbon oils.

### BACKGROUND OF THE INVENTION

One of the most economical methods of transporting liquid petroleum fuels, such as crude oil, fuel oil, heavy diesel oil and lubricating oil, has been by maritime carriers and, unfortunately, this has led to considerable pollution problems on the high seas and on waterways.

While water pollution occurs through accidental oil spills, an equally serious source of pollution is the petroleum fuel that is discharged by carriers during the washing of the emptied compartment tanks, and from the dirty ballast water. The cargo compartments contain considerable amounts of residual fuel oil after they have been emptied and they must be cleaned prior to dry dock work to eliminate a fire hazard.

There is another problem that has to be considered in the washing of the cargo tanks after the oil has been discharged. Serious explosions may occur during the washing procedure, or later on passage. The washing techniques in very large crude carriers involve the use of high velocity rotating jets of cold, clean, unrecirculated sea water, usually at flow rates of approximately 180 tons per hour at 140 psig. The disintegration of the water jet on the tank walls has been shown to give rise to a cloud of charged water droplets, and it is thought that this electrostatic condition is responsible for explosions. Obviously it would be very desirable to reduce these electrostatic hazards. Crude oil, however, is an impure product containing insoluble solids and sludge, and the heavy deposits formed on the tank surfaces necessitate stringent cleaning methods. One possible solution would be to use lower pressure water containing chemical detergents; however, the toxicity of the chemical detergents on marine life would have to be considered. Present indications are that the use of chemical detergents would add to the pollution problem, unless the cleaning operation was carried out at a shore facility having regulated disposal procedures.

U.S. Pat. No. 3,941,692 to Gutnick et al discloses a method of cleaning oil tanks by adding a microbial organism to oil-containing sea water in the tank, along with a source of nitrogen and a source of phosphorus and converting the resultant mixture to a non-oily form with said microbial organism or the products of said microbial organism under aerobic conditions. The method requires pre-flooding of the tank with sea water, resulting in the need to discharge these large quantities of water in port, or at sea.

Thus, it would be very desirable to develop other economical methods of cleaning cargo tanks without concurrently increasing the hazard of explosion or the danger of water pollution.

### SUMMARY OF THE INVENTION

According to a first aspect of the present invention, there is provided a system for cleaning oil tanks comprising: a bio-reactor for producing bacterial cultures containing bio-emulsifiers from bacteria, air, water and sources of utilizable carbon, nitrogen and phosphate; a first pump for pumping the bacterial cultures from the bio-reactor; a first pipe having a first end connected to the first pump and a second end connected to the oil tank, for feeding the bacterial cultures into the oil tank; at least one spraying nozzle connected to the first pipe at said second end, for spraying the bacterial cultures onto the oil tank's floor and walls under anaerobic conditions; a second pump for pumping fluid out of the oil tank; and a second pipe having a first end connected to said second pump and a second end connected to a receiving container, for flowing fluid out of the oil tank and into the receiving container.

According to a first embodiment of this aspect, the bacteria are a mixed marine hydrocarbon-degrading bacterial culture and the water is sea water.

According to a second embodiment of this aspect, the bacteria are a mixed fresh water hydrocarbon-degrading bacterial culture and the water is fresh water.

According to a third embodiment of this aspect, the receiving container is the bio-reactor.

According to a fourth embodiment of this aspect, the bio-reactor operates in a continuous mode.

According to a fifth embodiment of this aspect, the receiving container is a second oil tank.

According to a second aspect of the present invention there is provided a method of cleaning oil tanks comprising the steps of: a. producing bacterial cultures containing bio-emulsifiers from bacteria, air, water and sources of utilizable carbon, nitrogen and phosphate in a bio-reactor; b. spraying the bacterial cultures onto the walls and floor of an empty oil tank under anaerobic conditions; and c. pumping the resulting fluid from the oil tank.

According to a first embodiment of this aspect, the method additionally comprises the step of: d. re-circulating said pumped fluid into the bio-reactor.

According to a second embodiment of this aspect, steps (b) through (d) are repeated.

According to a third embodiment of this aspect, the method additionally comprising the step of: e. producing additional bacterial cultures in said bio-reactor, wherein air, nitrogen and phosphate are added to the bio-reactor.

According to a fourth embodiment of this aspect, steps (b) through (e) are repeated.

According to a fifth embodiment of this aspect, the method additionally comprises the step of: d. flowing the pumped fluid into a second oil tank.

According to a sixth embodiment of this aspect, steps (b) through (d) are repeated.

According to a seventh embodiment of this aspect, the bacteria are a mixed marine hydrocarbon-degrading bacterial culture and the water is sea water.

According to a eighth embodiment of this aspect, the bacteria are a mixed fresh water hydrocarbon-degrading bacterial culture and the water is fresh water.

According to a ninth embodiment of this aspect, the method additionally comprises the step of flowing carbon dioxide or any inert gas into the oil tank prior to step (b).

### BRIEF DESCRIPTION OF THE DRAWINGS

FIG. 1 is a schematic representation of a first embodiment of the system of the present invention;

FIG. 2 is a schematic representation of a second embodiment of the system of the present invention;

FIG. 3 shows the results of cleaning oil-contaminated flasks with a mixed marine hydrocarbon-degrading bacterial culture, according to the present invention; and

FIG. 4 shows the results of cleaning oil-contaminated flasks with a mixed fresh-water hydrocarbon-degrading bacterial culture, according to the present invention.

### DETAILED DESCRIPTION OF PREFERRED EMBODIMENTS

The present invention discloses a system and method using bioremediation for cleaning oil compartments, either at sea or on land, that overcome the shortcomings of existing methods.

Bioremediation is a natural process that uses biological systems, usually microorganisms, to transform harmful substances into non-toxic materials.

According to the method of the present invention, bacterial cultures containing bio-emulsifiers are produced in a separate tank or bio-reactor, by supplying selected bacteria with growth conditions including air, water and sources of utilizable carbon, nitrogen and phosphate. The carbon source may be crude or refined oil. The bio-reactor may be located on board the ship, in the port, or at any other suitable location. Growing the bacteria in a separate tank that is filled with water eliminates the explosion hazards. The bacterial culture, containing the bio-emulsifier, can then be safely used to clean the cargo compartments under anaerobic conditions.

The present invention is operable using any single or mixed group of bacteria that can produce emulsifiers, as reviewed by Rosenberg, E. and E. Z. Ron, 1999, High- and low-molecular mass microbial surfactants. Appl. Microbiol. Biotechnol. 65:2697-2702 (incorporated herein by reference).

The water supplied to the bio-reactor may be sea water or fresh water, depending on the selected bacteria and on the location of the bio-reactor.

Experiments have proven that the amount of washing fluid required to wash a tank is 1% to 5% of the tank's volume. For example, the product of a bio-reactor of 500 tons suffices for washing a tank of 10,000 tons. Thus, the system of the present invention produces a relatively small amount of dirty fluid to be disposed of, as compared to prior art methods of flooding the oil tank with cleaning fluid.

Once the bacterial culture containing bio-emulsifiers has been produced in the bio-reactor, it may now be used to wash the oil tank from oil residues and sludge. The washing may be done through a hatch in the oil tank's roof, by using spray nozzles such as, for example, SNS-100 or TZ-67, available from Oreco, Denmark, or MultiJet 40, available from Toftejorg, Oxfordshire UK. The washing fluid is then pumped from the bottom of the tank and may be re-circulated, either to the same tank for additional washing, or to a second tank. Experiments have shown that up to four oil tanks may be cleaned in series with the original amount of bacterial culture containing bio-emulsifiers, thus further reducing the amount of contaminated fluids to be discharged.

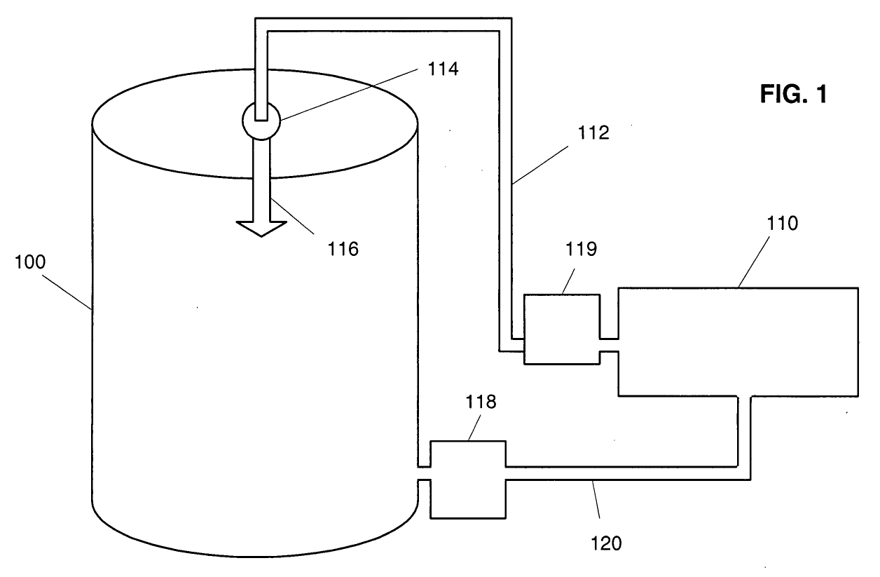

According to a first embodiment of the present invention, schematically shown in FIG. 1, the bio-reactor may be located on board the ship, either as a special tank, or using the ship's slop tank, or any other suitable container. Alternatively, the bio-reactor and the oil tank(s) may be located on land.

The bacterial culture containing bio-emulsifiers is pumped from bio-reactor (110) by pump (119), and flows through pipe (112), into oil tank (100), entering the tank through hatch (114). The flow of the washing fluid makes the nozzles (116) (only one shown) perform a geared rotation around the vertical and horizontal axes, laying out a pattern on the tanks floor and walls and washing the dirt sticking to them. Pump (118) pumps the dirty fluid back to bio-reactor (110) through pipe (120). This cycle may be repeated as many times as necessary.

In a second embodiment of the present invention, the bioreactor (110) may be used in either a batch mode or a continuous mode. When preparing the initial bacterial culture, prior to commencing the washing procedure, the reactor will be used in the batch mode. The dissolved oxygen will be monitored and maintained at 10-90% saturation by controlling the air flow and/or agitation. The sources of utilizable nitrogen and phosphorus will be added so that the ratios of C/N and C/P will be in ranges of 5-15 and 20-50, respectively.

Once the washing procedure begins, the bioreactor (110) may run in a continuous mode, with the flow in (from the tank (100) being washed) equal to the flow out (to the next tank being washed). Aeration will be continued as described above. Since the in-flow will bring additional carbon compounds (e.g., oil from the tank being washed), additional nitrogen and phosphorus nutrients will be added to maintain the C/N and C/P ratios described above.

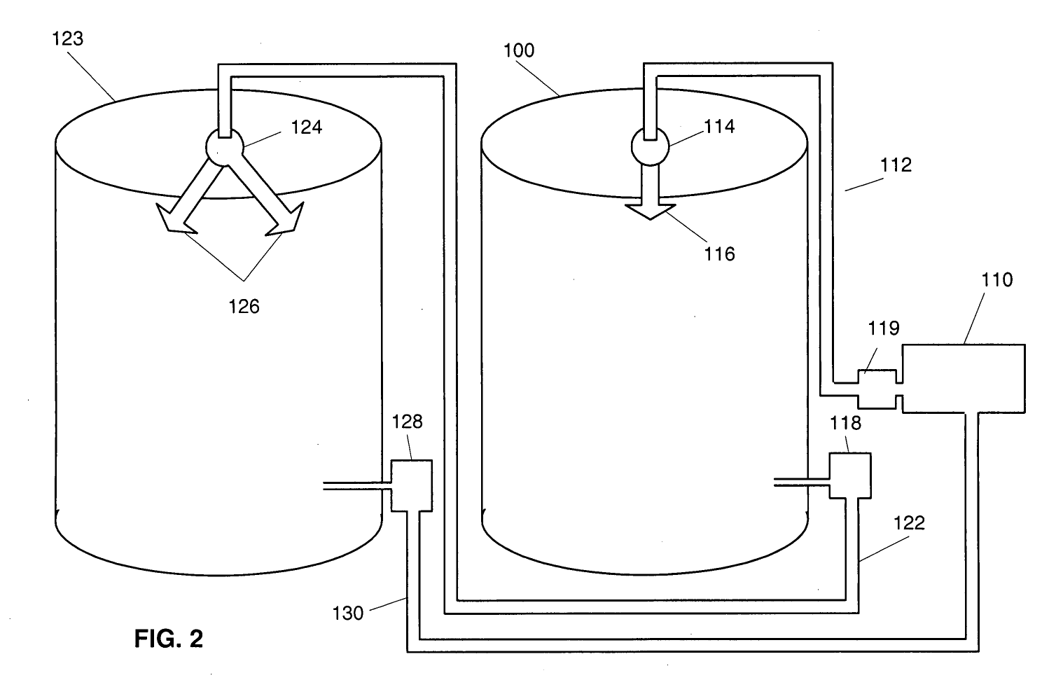

FIG. 2 schematically presents a third embodiment of the present invention. Similar to the embodiment of FIG. 1, the bacterial culture containing bio-emulsifiers flows from bio-reactor (110) to oil tank (100) through pipe (112) and hatch (114). Pump (118) in this embodiment pumps the dirty fluid into pipe (122), which feeds a second oil tank (123). The washing fluid enters tank (123) through hatch (124) and operates nozzles (126) as has been described above. Pump (128) pumps the dirty fluid back to bio-reactor (110), through pipe (130). This cycle may be repeated as many times as necessary.

Alternatively and similar to what has been described above, pipe (130) may lead the washing fluid to a third tank to be cleaned.

According to some embodiments of the present invention, carbon dioxide from the ship's chimney, or any inert gas, may be pumped into the oil tank prior to the washing, pushing out the oxygen from the tank and reducing explosion hazards. This is in contrast with prior biological art cleaning methods, where the oxygen was needed in the tank to enable the bacteria to grow.

Experiment 1: Cleaning of oil-contaminated flasks with a mixed marine hydrocarbon-degrading bacterial culture. The culture was obtained by inoculating flasks containing 0.5% crude oil, 0.1% urea and 0.2% potassium dihydrogen phosphate in seawater with oil-contaminated beach sand. After shaking for 4 days at 30° C., the culture (1%) was transferred to a flask containing the same medium and shaking continued. After the second transfer, transfers were performed weekly to maintain the mixed culture.

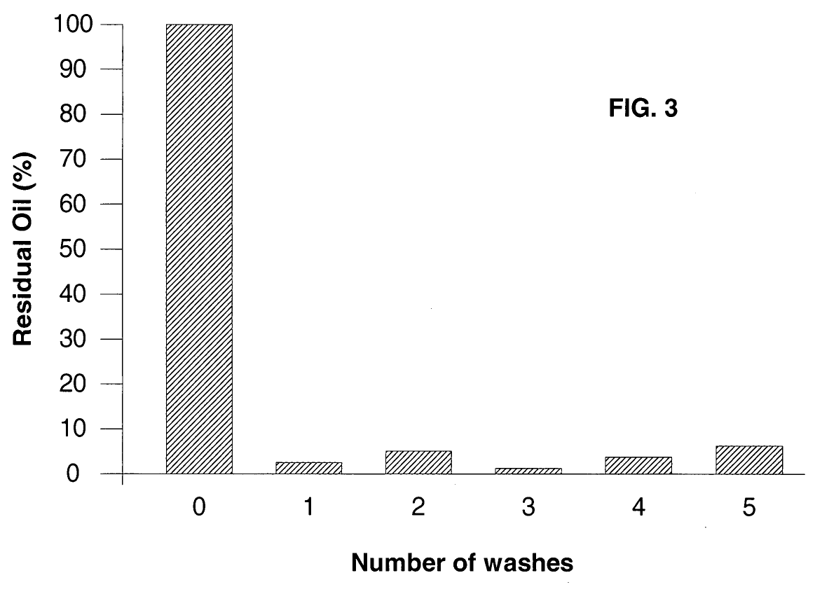

To twelve 250 ml flasks were added 0.2 ml crude oil. The oil was spread on the bottom and allowed to adhere to the flask by standing 24 hours. The flasks were then washed successively with 10 ml of a 3-day mixed culture of oil-degrading bacteria as described above. Each was mixed for 5 minutes. The liquid was then removed and the amount of residual oil was determined by extracting the oil remaining in the flask with 10 ml chloroform and measuring absorption in a Klett-Summerson colorimeter. The results are shown in FIG. 3.

Experiment 2: Cleaning of oil-contaminated flasks with a mixed fresh water hydrocarbon-degrading culture.

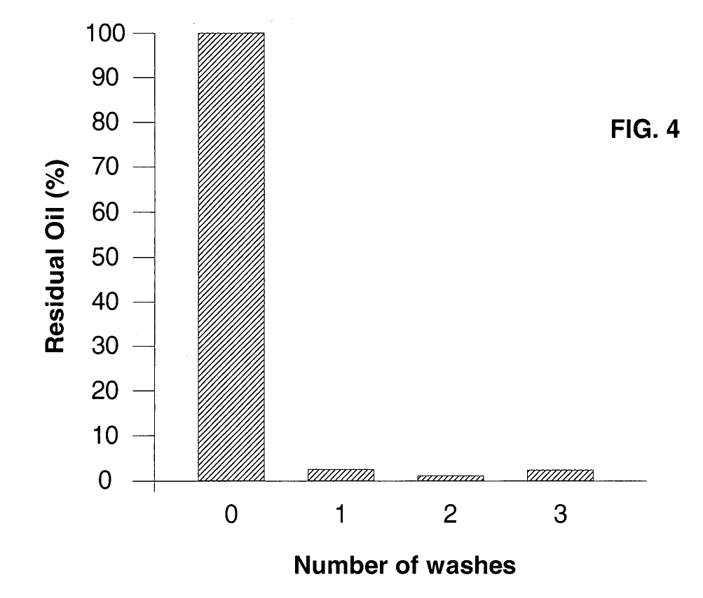

The experiment was performed as described in experiment 1, except that the medium contained fresh water in place of seawater and the original inoculum was oil contaminated soil obtained from a gas station. The results are shown in FIG. 4.

1. A system for cleaning oil tanks comprising:
a bio-reactor for producing bacterial cultures containing bio-emulsifiers from bacteria, air, water and sources of utilizable carbon, nitrogen and phosphate;
a first pump for pumping the bacterial cultures from the bio-reactor;
a first pipe having a first end connected to the first pump and a second end connectable to an oil tank, for feeding the bacterial cultures into the oil tank;
at least one spraying nozzle connected to the first pipe at said second end, for spraying the bacterial cultures onto the oil tank's floor and walls under anaerobic conditions;
a second pump for pumping fluid out of the oil tank; and
a second pipe having a first end connected to said second pump and a second end connectable to a receiving container, for flowing fluid out of the oil tank and into the receiving container.

2. The system according to claim 1, wherein said bacteria are a mixed marine hydrocarbon-degrading bacterial culture and said water is sea water.

3. The system according to claim 1, wherein said bacteria are a mixed fresh water hydrocarbon-degrading bacterial culture and said water is fresh water.

4. The system according to claim 1, wherein said receiving container is the bio-reactor.

5. The system according to claim 4, wherein said bio-reactor operates in a continuous mode.

6. The system according to claim 1, wherein said receiving container is a second oil tank.

7. A method of cleaning oil tanks comprising the steps of:
a. producing bacterial cultures containing bio-emulsifiers from bacteria, air, water and sources of utilizable carbon, nitrogen and phosphate in a bio-reactor;
b. spraying said bacterial cultures onto the walls and floor of an empty oil tank under anaerobic conditions; and
c. pumping the resulting fluid from said oil tank.

8. The method according to claim 7, additionally comprising the step of: d. re-circulating said pumped fluid into said bio-reactor.

9. The method according to claim 8, wherein steps (b) through (d) are repeated.

10. The method according to claim 8, additionally comprising the step of:
e. producing additional bacterial cultures in said bio-reactor, wherein air, nitrogen and phosphate are added to the bio-reactor.

11. The method according to claim 10, wherein steps (b) through (e) are repeated.

12. The method according to claim 7, additionally comprising the step of:
d. flowing said pumped fluid into a second oil tank.

13. The method according to claim 12, wherein steps (b) through (d) are repeated.

14. The method according to claim 7, wherein said bacteria are a mixed marine hydrocarbon-degrading bacterial culture and said water is sea water.

15. The method according to claim 7, wherein said bacteria are a mixed fresh water hydrocarbon-degrading bacterial culture and said water is fresh water.

16. The method according to claim 7, additionally comprising the step of flowing carbon dioxide into said oil tank prior to step (b).
